(19) United States
(12) Patent Application Publication
(10) Pub. No.: US 2026/0054244 A1
(43) Pub. Date: Feb. 26, 2026

(54) APPARATUS FOR MASS-PRODUCING LITHIUM SULFIDE

(71) Applicant: LAKE TECHNOLOGY., LTD, Sejong-si (KR)

(72) Inventors: Sang Yun LEE, Sejong-si (KR); Seong Hoon JEONG, Cheonan-si Chungcheongnam-do (KR); Sung Yoon BAEK, Sejong-si (KR); Taek Seung YANG, Icheon-si Gyeonggi-do (KR); Chang Ho SONG, Cheongju-si Chungcheongbuk-do (KR); Jin Dong KIM, Sejong-si (KR)

(73) Assignee: LAKE TECHNOLOGY., LTD, Sejong-si (KR)

(21) Appl. No.: 19/375,703

(22) Filed: Oct. 31, 2025

Related U.S. Application Data
(63) Continuation of application No. PCT/KR2024/005089, filed on Apr. 16, 2024.

(30) Foreign Application Priority Data
May 15, 2023 (KR) 10-2023-0062604

(51) Int. Cl. B01J 19/02; C01B 17/22

(52) U.S. Cl. CPC B01J 19/02; C01B 17/22; B01J 2219/00087; B01J 2219/0263; B01J 2219/0286

(57) ABSTRACT

Provided is an apparatus for mass-producing lithium sulfide that includes: a reaction chamber having a reaction space for producing lithium sulfide and provided with a lithium raw material; a hydrogen sulfide supply portion provided to supply hydrogen sulfide to the reaction chamber; a heating portion provided to heat the reaction space; a lithium sulfide recovery portion provided to remove impurities from the lithium sulfide produced by a reaction between the hydrogen sulfide and the lithium raw material in the reaction chamber and recover only pure lithium sulfide; a condensation portion provided to recover and condense gas discharged from the reaction chamber; a solvent re-supply portion provided to receive a mixture from the condensation portion, selectively separate a reaction solvent, and supply the separated reaction solvent into the reaction chamber; and a moisture removal portion provided to remove water vapor from recovered gas delivered from the solvent re-supply portion.

### CROSS-REFERENCE TO RELATED APPLICATIONS

This application is a continuation of International Application No. PCT/KR2024/005089 filed on Apr. 16, 2024, which claims priority to Korean Patent Application No. 10-2023-0062604 filed on May 15, 2023, the entire contents of which are herein incorporated by reference.

### TECHNICAL FIELD

The present invention relates to an apparatus for economically mass-producing lithium sulfide.

### BACKGROUND ART

Lithium secondary batteries have high energy density and long lifetimes, and thus they are widely used in electronic devices such as home appliances, laptop computers, and smartphones. Recently, their utilization has been greatly increasing, as they are also mounted on electric vehicles (EVs) and hybrid electric vehicles (HEVs).

Lithium-ion secondary batteries that are mainly used today have been widely used as the main power source for mobile phones, laptop computers, and PCs since mass production began in 1991, thanks to their high energy density and output voltage. However, an organic electrolyte that is included to facilitate the migration of lithium ions includes a risk of explosion under overheating and overcharging conditions. Furthermore, it may easily ignite in the presence of an ignition source, and side reactions within the battery may cause gas generation, deteriorating battery performance and stability.

To overcome these shortcomings of lithium-ion secondary batteries, active research and development is underway on all-solid-state lithium secondary batteries. All-solid-state lithium secondary batteries not only reduce the risk of explosion by employing a solid electrolyte instead of a volatile electrolyte, but also offer the advantage of dramatically improving battery energy density by allowing the use of lithium metal or a lithium alloy as a negative electrode material.

Today, among the solid electrolyte candidates that may be included in all-solid-state batteries, sulfide-based solid electrolytes, known for their high ductility and ionic conductivity, are evaluated as suitable for manufacturing high-capacity, large-scale secondary batteries, and lithium sulfide (Li₂S) is evaluated as a key material in the manufacturing process of such sulfide-based solid electrolytes. Various methods of synthesizing lithium sulfide are known, but the most common method is known to be allowing lithium metal, such as lithium hydroxide (LiOH) or lithium carbonate (Li₂CO₃), to react with hydrogen sulfide (H₂S).

Meanwhile, hydrogen sulfide gas is highly corrosive, when allowed to react with lithium metal in a conventional metal reactor, there was a problem in that the reactor, piping, and other equipment were corroded, leading to frequent repairs and replacements, thus lowering the economic feasibility of mass producing lithium sulfide.

In addition, reacting lithium metal, such as lithium hydroxide, with hydrogen sulfide inevitably generates water vapor, which not only interferes with the contact between lithium metal and hydrogen sulfide, reducing the yield of lithium sulfide, but also reacts with lithium sulfide to accelerate a reverse reaction of lithium sulfide into lithium hydroxide, thereby reducing the purity of the resulting lithium sulfide. Furthermore, moisture may cause agglomeration between the produced lithium sulfide particles, deteriorating product quality.

Accordingly, the present inventors have studied a method for improving economic feasibility by utilizing a reaction of lithium metal and hydrogen sulfide to produce lithium sulfide, while producing lithium sulfide in large quantities under relatively mild conditions and removing moisture from unreacted hydrogen sulfide to reuse it in producing lithium sulfide, thereby completing the present invention.

### SUMMARY

### Technical Problem

The present invention has been proposed to solve the above-described problems and aims to provide an apparatus for mass-producing lithium sulfide with high purity and high yield by designing a reactor with specific material and temperature conditions suitable for mass-producing lithium sulfide with high purity and high yield through a reaction between lithium metal and hydrogen sulfide, and further, selectively removing water vapor from the gas generated during the reaction and then re-supplying hydrogen sulfide into the reactor.

### Technical Solution

In one example, an apparatus for mass-producing lithium sulfide includes: a reaction chamber having a reaction space for producing lithium sulfide and provided with a lithium raw material; a hydrogen sulfide supply portion provided to supply hydrogen sulfide to the reaction chamber; a heating portion provided to heat the reaction space; a lithium sulfide recovery portion provided to remove impurities from the lithium sulfide produced by a reaction between the hydrogen sulfide and the lithium raw material in the reaction chamber and recover only pure lithium sulfide; a condensation portion provided to recover and condense gas discharged from the reaction chamber; a solvent re-supply portion provided to receive a mixture from the condensation portion, selectively separate a reaction solvent, and supply the separated reaction solvent into the reaction chamber; and a moisture removal portion provided to remove water vapor from recovered gas delivered from the solvent re-supply portion and then supply only hydrogen sulfide gas to a bottom of the reaction chamber, a hydrogen sulfide supply portion, or a hydrogen sulfide supply line.

In another example, a stirring member may be further provided in the reaction chamber to promote a reaction between the supplied hydrogen sulfide and the lithium raw material.

In still another example, the reaction chamber may be made of one or more materials selected from the group consisting of Hastelloy X, stainless steel 304 (SUS 304), stainless steel 310 (SUS 310), stainless steel 316 (SUS 316), alumina, quartz, and a combination thereof.

In yet another example, the heating portion may be mounted on an outer surface of the reaction chamber and may heat the reaction space to a temperature to 120° C. or more and less than 300° C.

In yet another example, the lithium raw material supplied to the reaction chamber may have a particle size of 1 mm or less.

In yet another example, the solvent re-supply portion may be a Dean-Stark trap.

In yet another example, the moisture removal portion may be a desublimation cooling portion that cools the gas recovered from the solvent re-supply portion and selectively removes only moisture from the gas.

In yet another example, the desublimation cooling portion may include a plurality of cooling chambers and a control portion controlling the desublimation cooling portion, and the control portion may control cooling so that, when the recovered gas is transferred to one or more predetermined cooling chambers among the plurality of cooling chambers, cooling is performed in the cooling chamber to which the recovered gas is transferred.

In yet another example, the control portion may control the cooling chamber to which the recovered gas is transferred, so that after cooling operation is performed for a predetermined time, the recovered gas is transferred to another cooling chamber, and cause heating to be performed for the cooling chamber that has performed cooling for the predetermined time to liquefy and remove ice desublimated by cooling.

In yet another example, the desublimation cooling portion may have a plurality of branch lines for transferring the recovered gas to each of the plurality of cooling chambers and valves installed at the branch lines to open and close each of the branch lines, and the control portion may be configured to determine a cooling chamber to which the recovered gas is transferred by controlling the valves.

In yet another example, the desublimation cooling portion may have a main body provided to be rotatable around an axis parallel to a direction in which the recovered gas is transferred, the plurality of cooling chambers may be formed to pass through the main body in a direction parallel to the axis, and at least one of the cooling chambers may be provided to communicate with a recovery line through which the recovered gas is transported and a re-supply line through which the recovered gas is re-supplied to the reaction chamber, and the control portion may control the cooling chamber performing cooling to communicate with the recovery line and the re-supply line by rotating the main body around the axis.

In yet another example, the control portion may control the recovery line to communicate with another cooling chamber scheduled to perform a cooling operation by rotating the main body around the axis after the cooling chamber to which the recovered gas is transferred has been cooled for a predetermined time and cause heating to be performed for the cooling chamber that has been cooled for the predetermined period time to liquefy and remove ice desublimated by cooling.

In yet another example, the hydrogen sulfide supply portion may a hydrogen sulfide reactor including an outer chamber and an inner chamber provided within the outer chamber so that a separation space is formed between the outer chamber and the outer chamber and having a reaction space for synthesizing hydrogen sulfide, and the inner chamber in the reactor may have higher corrosion resistance than the outer chamber.

### Advantageous Effects

According to the present invention, when producing lithium sulfide through the reaction between lithium metal and hydrogen sulfide, the reaction is performed under relatively mild conditions compared to conventional techniques, and therefore, frequent repairs or replacements due to corrosion and malfunctions of the reactor and piping are not required, thereby improving the economic feasibility of the process.

In addition, water vapor (moisture), a byproduct of the reaction, is effectively removed, preventing the reverse reaction into lithium hydroxide and promoting the forward reaction as well as the agglomeration of lithium sulfide particles, so that high-quality lithium sulfide can be mass-produced with high purity and yield.

Furthermore, by re-supplying the reaction solvent and unreacted hydrogen sulfide into the reaction chamber, the hydrogen sulfide reaction rate can be improved, thereby ensuring the economic feasibility of the process.

### DESCRIPTION OF DRAWINGS

FIG. 1 is a schematic diagram illustrating an apparatus for mass-producing lithium sulfide according to one embodiment of the present invention.

FIG. 2 is a schematic diagram illustrating a desublimation cooling portion according to one embodiment of the present invention.

FIG. 3 is a perspective view illustrating a desublimation cooling portion according to another embodiment of the present invention.

FIG. 4 is a front view illustrating a desublimation cooling portion according to still another embodiment of the present invention.

FIG. 5 is a schematic diagram illustrating a hydrogen sulfide reactor included in a hydrogen sulfide supply portion according to one embodiment of the present invention.

FIG. 6 is a diagram illustrating a form in which an outer chamber and a cover of a hydrogen sulfide reactor according to one embodiment of the present invention are combined.

FIG. 7 is a diagram illustrating a form in which an inner chamber and a cover of a hydrogen sulfide reactor according to one embodiment of the present invention are combined.

### DETAILED DESCRIPTION

Hereinafter, embodiments of the present invention will be described in detail with reference to the accompanying drawings. When designating components in each drawing, it should be noted that, where possible, identical components are given the same reference numerals, even when they appear in different drawings. Furthermore, when describing embodiments of the present invention, detailed descriptions of known components or functions will be omitted when they are deemed to hinder understanding of the embodiments of the present invention.

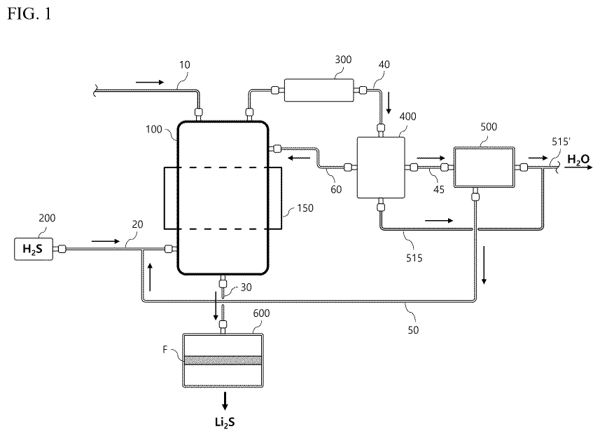

FIG. 1 is a schematic diagram illustrating an apparatus for mass-producing lithium sulfide according to one embodiment of the present invention. Hereinafter, an apparatus for mass-producing lithium sulfide according to one embodiment of the present invention will be described with reference to FIG. 1.

The apparatus for mass-producing lithium sulfide according to one embodiment of the present invention includes a reaction chamber 100, a heating portion 150, a hydrogen sulfide supply portion 200, a condensation portion 300, a solvent re-supply portion 400, a moisture removal portion 500, and a lithium sulfide recovery portion 600. Meanwhile, although not shown, a separately provided supply means, such as a circulation pump, may be used as a means for promoting material movement between components within the production apparatus.

The reaction chamber 100 is a chamber having a reaction space for producing lithium sulfide. Lithium raw material and hydrogen sulfide react in the reaction space to synthesize lithium sulfide. A reaction solvent for inducing a wet reaction may be provided in the reaction chamber 100. Specifically, the reaction solvent may be selected from hexane, octane, decane, dodecane, toluene, xylene (o-, m-, p-xylene), and combinations thereof or may be a non-polar solvent. Meanwhile, the method of supplying the lithium raw material is not particularly limited. For example, the lithium raw material may be supplied by being charged into the reactor all at once, or a conveyor belt or the like may be installed on the outside of the reaction chamber 100 to implement an automated/semi-automated process. In addition, a lithium raw material supply line 10 provided at the reaction chamber 100 may be formed to be inclined so that the lithium raw material may move into the reaction chamber by gravity. In addition, the lithium raw material may be moved by using a ventilation means such as a blower. Meanwhile, a stirring member (not shown) may be further provided within the reaction chamber to promote the reaction. For example, a rotating disk, a rotary stirrer, a propeller, or the like may be employed, but the stirring member is not particularly limited thereto.

The hydrogen sulfide supply portion 200 is provided to supply hydrogen sulfide to the reaction chamber 100. Specifically, the hydrogen sulfide supply portion 200 may be provided adjacent to a lower portion of one side of the reaction chamber so as to supply hydrogen sulfide into the reaction chamber. Meanwhile, an in-line disperser (not shown) for generating bubbles in hydrogen sulfide may be provided in the hydrogen sulfide supply line 20 between the hydrogen sulfide supply portion and the reactor. The in-line disperser may be a device that mixes supplied fluids by high-speed rotation of a rotor at high pressure, and the in-line disperser may be controlled to have optimal pressure and temperature ranges for supplying hydrogen sulfide in a bubbled state.

Meanwhile, the lithium raw material provided in the reaction chamber may be lithium hydroxide (LiOH) or lithium carbonate (Li₂CO₃), specifically lithium hydroxide. Specifically, lithium hydroxide supplied to the reaction chamber 100 may react with hydrogen sulfide to produce lithium sulfide as shown in Chemical Equation 1 below. In other words, it can be seen that when lithium hydroxide and hydrogen sulfide react, water is generated as a byproduct.

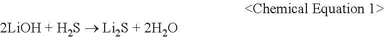

According to one embodiment of the present invention, the supplied lithium raw material may have a particle size of 1 mm or less. Therefore, the reaction area with hydrogen sulfide may be increased, so that high-purity lithium sulfide is produced.

Meanwhile, the heating portion 150 is provided to heat the reaction space. The method by which the heating portion 150 heats the reaction space is not particularly limited. For example, the heating portion 150 may be a heater, an electric heating wire, or an infrared heater mounted on an outer surface of the reaction chamber 100.

In addition, the heating portion 150 may heat the reaction space to a temperature of 120° C. or more and less than 300° C., specifically 140° C. or more and less than 300° C., and more specifically 160° C. or more and less than 300° C. In order for the lithium raw material and hydrogen sulfide to react smoothly, the lithium raw material (lithium hydroxide) needs to be sufficiently heated. In addition, as described above, water (H₂O) is generated as a by-product by the reaction of lithium hydroxide and hydrogen sulfide, and when water is present in a liquid state, there is a concern that the water may flow between lithium hydroxide particles, reducing the area of lithium hydroxide reacting with hydrogen sulfide. Therefore, by heating the reaction space to a temperature of the temperature 120° C., specifically 140° C., and more specifically 160° C. or more to evaporate the water, high-purity lithium sulfide can be obtained.

Meanwhile, the higher the temperature of the reaction space, the more accelerated the reaction between lithium hydroxide and hydrogen sulfide. However, since the melting point of lithium hydroxide is 445° C., it is preferable that the temperature of the reaction space does not exceed 445° C.

In addition, as the temperature of the reaction space increases, there is a greater risk of corrosion of an inner surface of the reaction chamber 100 by hydrogen sulfide. Therefore, the reaction chamber 100 may be made of a material with high heat resistance and corrosion resistance. For example, the reaction chamber 100 may be made of one or more materials selected from the group consisting of Hastelloy X, stainless steel 304 (SUS 304), stainless steel 310 (SUS 310), stainless steel 316 (SUS 316), alumina, quartz, and a combination thereof. In addition, the heating portion 150 may heat the reaction space to a temperature less than 300° C. Accordingly, frequent repair or replacement of equipment such as piping of the reaction chamber 100 can be prevented, and the reaction between hydrogen sulfide and the lithium raw material can be sufficiently promoted to obtain high-purity lithium sulfide.

The condensation portion 300 may be provided to recover gas discharged from the reaction chamber 100 along an exhaust line 40 and condense it, and a separate cooling means (not shown) may be provided for this purpose. The condensation portion may be, for example, a condenser utilizing a heat exchange method.

The solvent re-supply portion 400 may be configured to receive a mixture from the condensation portion, selectively separate only the reaction solvent through distillation or the like, and re-supply the separated reaction solvent into the reaction chamber 100. Meanwhile, the mixture delivered from the condensation portion may be in a form in which gas and liquid phases are mixed, and specifically, may be a mixture in which hydrogen sulfide (H₂S), the reaction solvent, and water vapor (H₂O) are mixed. As a specific example, the solvent re-supply portion 400 may be a Dean-Stark trap, and when the Dean-Stark trap is applied, the reaction solvent and water are separated from the mixture by the difference in specific gravity, and the separated reaction solvent is re-supplied to the reaction chamber along a solvent re-supply line 60, and the water may be primarily removed along a discharge line 515.

The lithium sulfide recovery portion 600 may further include a filter member F to recover lithium sulfide and remove impurities to further increase the purity of the lithium sulfide. For example, lithium sulfide generated through the reaction between hydrogen sulfide and the lithium raw material in the reaction chamber 100 may be recovered through a lithium sulfide recovery line 30 and then filtered by the filter member F to remove impurities. Meanwhile, the lithium sulfide recovery line 30 may be provided to communicate with a lower portion of the reaction chamber 100. Here, the lower portion of the reaction chamber 100 may mean a portion below the reaction space heated by the heating portion 150. The structure of the lithium sulfide recovery portion 600 is not particularly limited. For example, the recovery portion may be a chamber having a shape such as a rectangular shape, a rectangular shape, a cylindrical shape, or an inverted cone shape to effectively recover lithium sulfide. Meanwhile, the filter member F may be made of one or more materials selected from Hastelloy, stainless steel 304 (SUS 304), stainless steel 310 (SUS 310), stainless steel 316 (SUS 316), and a combination thereof and may be in the form of a mesh.

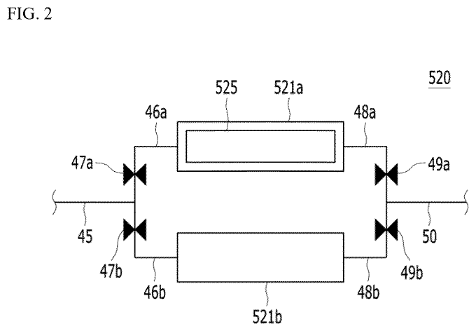

Meanwhile, FIG. 2 is a schematic diagram illustrating a moisture removal portion according to one embodiment of the present invention. Hereinafter, a moisture removal portion 500 according to one embodiment of the present invention will be described with reference to FIGS. 1 and 2 to 4.

The moisture removal portion 500 is provided to remove water vapor from the recovered gas that is delivered from the solvent re-supply portion 400 and then re-supply only the hydrogen sulfide gas from which the water vapor has been removed to the lower portion of the reaction chamber 100, the hydrogen sulfide supply portion 200, or the hydrogen sulfide supply line 20. As described above, unreacted hydrogen sulfide that has not yet reacted with the lithium raw material, water vapor generated by the reaction of hydrogen sulfide and lithium hydroxide, and the gasified reaction solvent may be discharged from the reaction chamber 100, and the reaction solvent and water are removed while passing through the condensation portion 300 and the solvent re-supply portion 400. Thereafter, the recovered gas, which is recovered from the solvent re-supply portion 400 and delivered to the moisture removal portion 500, mostly contains only hydrogen sulfide gas, but it may also contain a very small amount of water vapor that was not fully removed. Therefore, it is necessary to completely remove water vapor from the recovered gas and re-supply it to the reaction chamber 100.

To this end, the recovered gas delivered from the solvent re-supply portion 400 through a recovery line 45 may be delivered to the moisture removal portion 500. Meanwhile, a separate supply means, such as a circulation pump (not shown), may be additionally provided to re-supply the hydrogen sulfide gas from which water vapor has been removed in the moisture removal portion.

Specifically, referring to FIG. 2, the moisture removal portion 500 may be a desublimation cooling portion 520 that cools the gas recovered from the solvent re-supply portion and selectively removes only moisture from the recovered gas.

Meanwhile, the desublimation cooling portion 520 may be provided to perform secondary moisture removal by cooling the gas recovered from the solvent re-supply portion 400. For example, the water vapor may be desublimated and removed by cooling it to approximately −30° C. The desublimation cooling portion 520 may additionally remove water vapor (water) that is not removed in the solvent re-supply portion 400 by recovering the gas that passes through the solvent re-supply portion 400 through the recovery line 45. Meanwhile, the terms “primary” and “secondary” used throughout the present specification and claims should be understood as arbitrarily assigning a sequence for the purpose of distinction. Meanwhile, the terms “primary cooling” and “secondary cooling” do not mean a cooling sequence.

More specifically, the desublimation cooling portion 520 may include a cooling chamber 521, a cooling means 525 provided in the cooling chamber 521, and a control portion (not shown) that controls the desublimation cooling portion 520. The control portion may be a control portion that controls the apparatus for mass-producing lithium sulfide.

Water vapor supplied to the cooling chamber 521 may be desublimated by the cooling means 525 and freezes on an inner surface of the cooling chamber 521. Since hydrogen sulfide has a boiling point of −59.6° C., it may pass through the cooling chamber 521 as is. Therefore, the cooling chamber 521 may remove only water vapor from the recovered gas and re-supply hydrogen sulfide to the reaction chamber 100. However, since the desublimation cooling portion 520 causes a phase change by desublimating water vapor into an ice state and freezing it on an inner surface of the cooling chamber, in order to remove the frozen moisture on the inner surface of the cooling chamber 521, it is necessary to heat the cooling chamber 521 again to liquefy the ice. In other words, when only one cooling chamber 521 is provided, the operation of the apparatus for mass-producing lithium sulfide must be stopped in order to heat the cooling chamber 521, which makes it difficult to continuously carry out with the process.

Therefore, the desublimation cooling portion 520 according to one embodiment of the present invention may be provided with a plurality of cooling chambers 521a and 521b, a plurality of branch lines 46 for transferring the recovered gas to each of the plurality of cooling chambers 521a and 521b, and a plurality of second branch lines 48 for supplying the gas in the plurality of cooling chambers 521 to a re-supply line 50. The re-supply line 50 refers to a line that is provided to re-supply the recovered gas to a lower portion of the reaction chamber 100, the hydrogen sulfide supply portion 200, or the hydrogen sulfide supply line 20. In addition, the control portion may control cooling to be performed in the cooling chamber to which the recovered gas is transferred when the recovered gas is transferred to a preset cooling chamber among the plurality of cooling chambers 521.

The branch lines 46a and 46b and the second branch line 48a and 48b may be respectively provided with first to fourth branch valves 47a, 47b, 49a, and 49b. The control portion may be configured to determine the cooling chambers 521a and 521b to which the recovered gas is transferred by controlling the branch valves 47a, 47b, 49a, and 49b provided in the branch lines 46a and 46b and the second branch lines 48a and 48b. For example, in order to transfer the recovered gas to the cooling chamber 521a located on the upper side of FIG. 2, the first branch valve 47a and the third branch valve 49a may be opened, and the second branch valve 47b and the fourth branch valve 49b may be closed.

After the upper cooling chamber 521a, to which the recovered gas is transferred, has been cooled for a predetermined time, it is necessary to heat and remove the ice that has been desublimated and frozen on an inner wall of the cooling chamber 521a. In this case, the control portion may perform control to transfer the recovered gas to a lower cooling chamber 521b and operate the cooling means (not shown) provided in the lower cooling chamber 521b so that the lower cooling chamber 521b performs cooling. In other words, the first branch valve 47a and the third branch valve 49a may be closed, and the second branch valve 47b and the fourth branch valve 49b may be opened, thereby controlling the recovered gas to be transferred to the lower cooling chamber 521b. Accordingly, not only can lithium sulfide be continuously produced without stopping the lithium sulfide production device, but the lithium sulfide production efficiency can also be improved by additionally removing moisture from the recovered gas, and high-purity lithium sulfide can be obtained.

Meanwhile, the control portion may switches the upper cooling chamber 521a, which has been in cooling operation for a predetermined period of time, to heating, thereby liquefying and removing ice desublimated by cooling. A separate heating means may be provided in the cooling chamber 521, or moisture may be removed simply by stopping the operation of the cooling means 525 and maintaining the cooling chamber 521 at room temperature. The removed moisture may be transferred to the discharge portion 515′ and removed.

In addition, instead of respectively providing the branch valves 47a, 47b, 49a, and 49b in the branch lines 46a, 46b, 48a, and 48b, three-way valves (not shown) may be provided at the branch point of the recovery line 45 and the branch line 46, and at the branch point of the branch line 48 and the re-supply line 50. The control portion may also control the three-way valves to determine the chamber to which the recovered gas is transported.

In addition, the number of cooling chambers 521 is not particularly limited. When three or more cooling chambers 521 are provided, cooling may be performed simultaneously in multiple cooling chambers 521. The number of cooling chambers 521 may be appropriately provided depending on the amount of water vapor generated, based on, for example, the size of the reaction chamber 100, the temperature to which the heating portion 150 heats the reaction space, and the like.

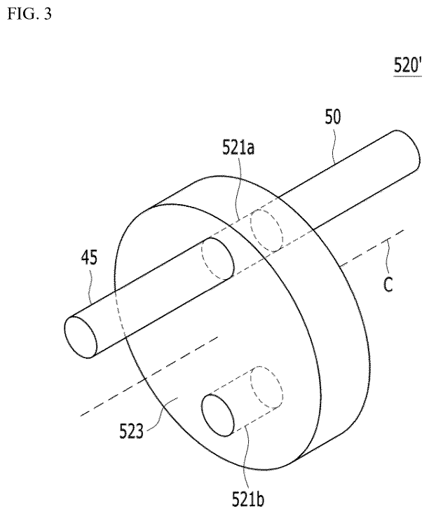

FIG. 3 is a perspective view illustrating a desublimation cooling portion according to another embodiment of the present invention. The desublimation cooling portion 520′ according to another embodiment of the present invention differs from the desublimation cooling portion 520 according to the above-described embodiment in that it has a main body 523 that is rotatable around an axis C parallel to the direction in which the recovered gas is transported. In addition, a plurality of cooling chambers 521 may be formed to pass through the main body 523 along the axis C parallel to the direction in which the recovered gas is transferred. In addition, the desublimation cooling portion 520′ according to the present embodiment does not have a branch line 46, but instead, at least one of the plurality of cooling chambers 521 may be provided to communicate with the recovery line 45 and the re-supply line 50.

In other words, the control portion may control some of the plurality of cooling chambers 521 to perform cooling, and by rotating the main body 523 around the axis C, the cooling chamber 521 performing cooling may be controlled to communicate with the recovery line 45 and the re-supply line 50.

More specifically, when the cooling chamber 521a located on the upper side of FIG. 3 is cooled by a cooling means (not shown) while being connected to the recovery line 45 and the re-supply line 50, as the recovered gas passes through the upper cooling chamber 521a, water vapor may be desublimated and frozen inside the cooling chamber, thereby being removed from the recovery gas. However, when the space inside the cooling chamber becomes small after the upper cooling chamber 521a through which the recovered gas is transferred has been cooled for a predetermined time, and the frozen ice needs to be removed, the control potion may control the lower cooling chamber 521b to perform cooling and then rotate the main body 523 around the axis C to change the cooling chamber 521 to which the recovered gas is transferred to the lower cooling chamber 521b. In addition, by switching the cooling chamber 521a in which cooling has been performed for a predetermined time to heating, the ice desublimated by cooling may be liquefied and removed.

Also in the desublimation cooling portion 520′ according to the present embodiment, the cooling chamber 521 to which the recovered gas is transferred may be changed simply by rotating the main body 523 around the axis C, so that lithium sulfide can be produced continuously without stopping the lithium sulfide production device, which is efficient, and since hydrogen sulfide from which moisture has been more thoroughly removed can be re-supplied to the reaction chamber, high-purity lithium sulfide can be obtained, and the economic feasibility of the process can be improved.

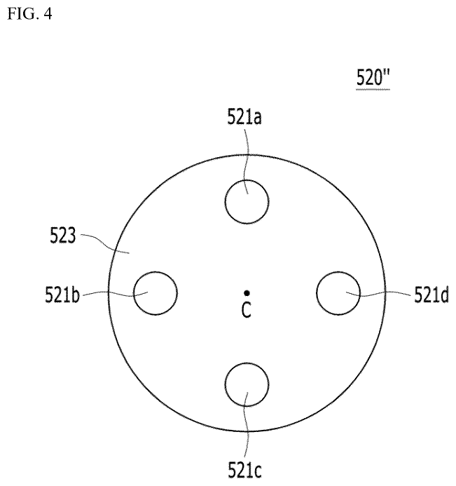

FIG. 4 is a front view illustrating a desublimation cooling portion according to still another embodiment of the present invention. The desublimation cooling portion 520″ according to this embodiment differs from the previously described desublimation cooling portion 520′ in that it includes three or more cooling chambers 521. The number of cooling chambers 521 is not particularly limited.

For example, as shown in FIG. 4, when four cooling chambers 521a, 521b, 521c, and 521d are formed to pass through the main body 523, at least one cooling chamber may be provided to communicate with the recovery line 45 and the re-supply line 50. In addition, the control portion may control sequential cooling operation of the plurality of cooling chambers 521a, 521b, 521c, and 521d and control transfer of the recovered gas to a cooling chamber where cooling is in progress, by rotating the main body 523 around the axis C. Likewise, for a cooling chamber that has been operated for a predetermined time, heating may be performed so that ice formed by sublimation through cooling may be liquefied and removed.

Alternatively, the desublimation cooling portion 520″ according to the present embodiment may be controlled to perform cooling in a plurality of cooling chambers 521a and 521b, and in this case, a plurality of lines branched from the recovery line 45 may be provided to communicate with each of the plurality of cooling chambers 521a and 521b that perform cooling. The number of cooling chambers 521 may be appropriately provided depending on the amount of water vapor generated based on, for example, the size of the reaction chamber 100, the temperature to which the heating portion 150 heats the reaction space, and the like.

The hydrogen sulfide gas discharged from the reaction chamber 100, recovered through the condensation portion 300 and the solvent re-supply portion 400, and from which moisture has been completely removed within the moisture removal portion 500 may be re-supplied into the reaction chamber through the re-supply line 50 at the lower portion of the reaction chamber 100, the hydrogen sulfide supply portion 200, or the hydrogen sulfide supply line 20 (see FIG. 1). The re-supply line 50 may be connected to one end of the lower side of the reaction chamber 100. In addition, the re-supply line 50 may also be connected to one side of the hydrogen sulfide supply portion 200 or the hydrogen sulfide supply line 20. Meanwhile, the lithium raw material supplied into the reaction chamber 100 falls to a lower side of the reaction chamber 100 by gravity and then reacts with the hydrogen sulfide supplied in the reaction solvent. At this time, the supplied hydrogen sulfide is supplied in a bubbled state into the reaction chamber by an in-line disperser or the like, so that the reaction area can be further increased, and thus the reaction with the lithium raw material can occur more smoothly.

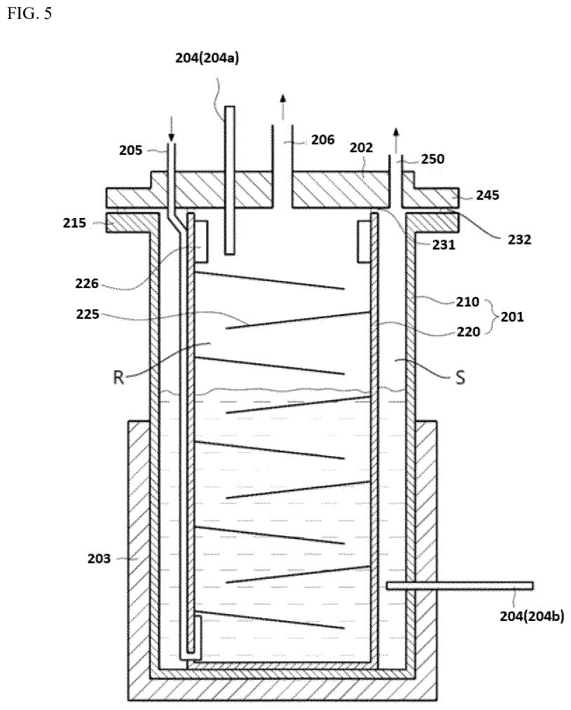

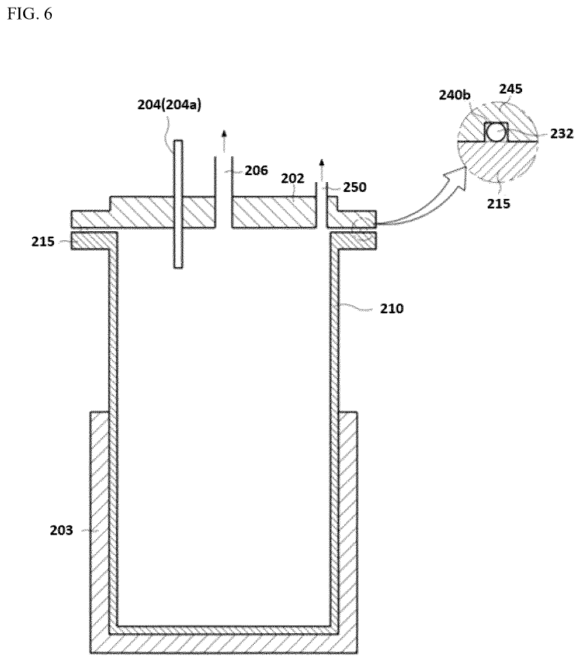

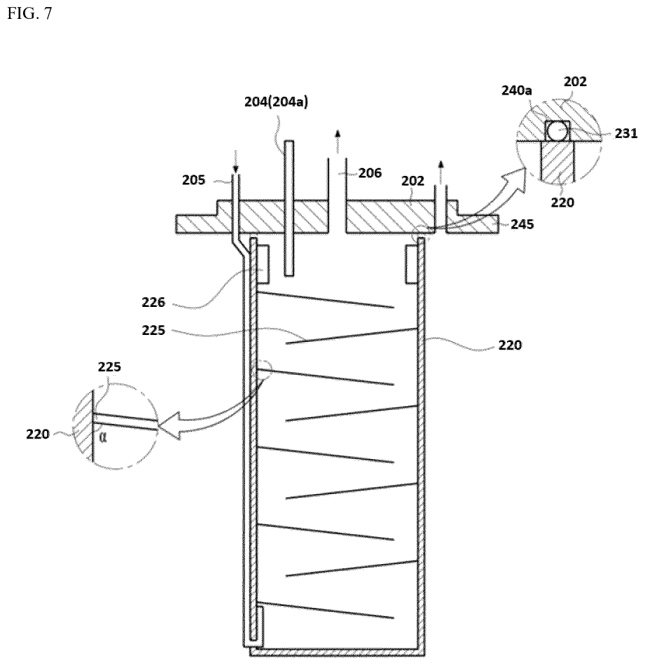

Meanwhile, the hydrogen sulfide supply portion 200 according to one embodiment of the present invention may be a hydrogen sulfide reactor including an outer chamber and an inner chamber provided within the outer chamber so that a separation space is formed between the outer chamber and the inner chamber and having a reaction space for synthesizing hydrogen sulfide, as illustrated in FIG. 5, and at this time, the inner chamber in the reactor may have higher corrosion resistance than the outer chamber. FIG. 6 illustrates a form in which an outer chamber and a cover of the hydrogen sulfide reactor are combined, and FIG. 7 illustrates a form in which an inner chamber and a cover of the hydrogen sulfide reactor are combined. Hereinafter, the hydrogen sulfide supply portion according to one embodiment of the present invention will be described with reference to FIGS. 5 to 7.

The hydrogen sulfide supply portion 200 according to one embodiment of the present invention may be a hydrogen sulfide reactor for synthesizing hydrogen sulfide, and the hydrogen sulfide reactor includes a hydrogen sulfide reaction chamber 201, a heating device 203, and a hydrogen gas supply pipe 205.

First, the hydrogen sulfide reaction chamber 201 is a chamber having a hollow reaction space R in which hydrogen sulfide synthesis takes place. Liquid sulfur may be stored in the hydrogen sulfide reaction chamber 201. For example, liquid sulfur may be supplied into the hydrogen sulfide reaction chamber 201 by a liquid sulfur supply pipe 204, which will be described later. In addition, hydrogen gas is supplied to the liquid sulfur accommodated in the hydrogen sulfide reaction chamber 201 by the hydrogen gas supply pipe 205, and the hydrogen gas and liquid sulfur react to synthesize hydrogen sulfide. Other components such as the liquid sulfur supply pipe 204, the hydrogen gas supply pipe 205, and the heating device 203 may be connected to the hydrogen sulfide reaction chamber 201. The shape of the hydrogen sulfide reaction chamber 201 is not particularly limited. The hydrogen sulfide reaction chamber 201 may have an outer chamber 210 and an inner chamber 220.

For example, the outer chamber 210 may be formed in a cylindrical shape with an open top. A ring-shaped chamber flange 215 protruding outward may be provided at an upper portion of the outer chamber 210. The outer chamber 210 may be made of one or more materials selected from the group consisting of, for example, Hastelloy X, stainless steel 304 (SUS 304), stainless steel 310 (SUS 310), stainless steel 316 (SUS 316), alumina, quartz, and a combination thereof.

The inner chamber 220 is provided within the outer chamber 210. The inner chamber 220 has a reaction space R for synthesizing hydrogen sulfide therein. The inner chamber 220 is arranged such that a separation space S is formed between the inner chamber and the outer chamber 210. For example, the inner chamber 220 may be formed in a cylindrical shape with an open top, like the outer chamber 210. Alternatively, the inner chamber 220 may be a partition wall extending upward from the bottom surface of the outer chamber 210, such that the separation space S is formed between the inner chamber and an inner surface of the outer chamber 210.

Meanwhile, the inner chamber 220 may be formed of a highly corrosion-resistant material, such as quartz. In other words, the inner chamber 220 may have higher corrosion resistance than the outer chamber 210. Therefore, when hydrogen sulfide is synthesized in the reaction space R within the inner chamber 220, corrosion of the inner chamber 220 by sulfur gas may be prevented.

However, when the inner chamber 220 is formed of a highly corrosion-resistant material, such as quartz, and heating is performed by directly installing a heating device 203 in the inner chamber 220, there is a risk that the inner chamber 220 may be damaged or destroyed by direct heating by the heating device. Therefore, the heating device 203 for heating the liquid sulfur accommodated in the reaction space R may be installed on an outer surface of the outer chamber 210.

In other words, the heating device 203 may indirectly heat the liquid sulfur accommodated in the reaction space R. More specifically, the liquid sulfur may be accommodated in each of the reaction space R and the separation space S. In addition, the heating device 203 may heat the liquid sulfur accommodated in the reaction space R, specifically, the liquid sulfur accommodated in a lower space of the hydrogen sulfide reaction chamber, to a temperature range of 300° C. to 600° C., specifically, to a temperature range of 400° C. to 500° C., via the liquid sulfur accommodated in the separation space S. The heating device 203 may be a heater, an electric heating wire, or an infrared heater, but the type thereof is not particularly limited.

The hydrogen sulfide reactor according to one embodiment of the present invention may include a liquid sulfur supply pipe 204. The liquid sulfur supply pipe 204 may include a first liquid sulfur supply pipe 204a provided to supply liquid sulfur to the reaction space R, and a second liquid sulfur supply pipe 204b provided to supply liquid sulfur to the separation space S. The first liquid sulfur supply pipe 204a may be provided to supply liquid sulfur to the reaction space R by passing through a cover 202 described below, and the second liquid sulfur supply pipe 204b may be provided to supply liquid sulfur to the separation space S by passing through the outer chamber 210.

Meanwhile, the hydrogen gas supply pipe 205 may be provided to supply hydrogen gas to a lower portion of the reaction space R. Specifically, the hydrogen gas supply pipe 205 may be provided to extend along a height direction of the inner chamber 220 in the separation space S and may supply hydrogen gas to the reaction space R through a through-hole (not shown) provided at a lower portion of the inner chamber 220.

The hydrogen sulfide reactor according to the present invention may further include a cover 202 mounted on the hydrogen sulfide reaction chamber 201. When the cover 202 is mounted on the hydrogen sulfide reaction chamber 201, it may form a reaction space R together with the inner chamber 220. The cover 202 may be provided with a ring-shaped cover flange 245 that protrudes to face the flange 215 of the outer chamber 210.

The cover 202 may be mounted on the hydrogen sulfide reaction chamber 201 with a sealing member 231 and 232 interposed therebetween. Referring to FIGS. 6 and 7, a first sealing member 231 may be provided between the cover 202 and the inner chamber 220, and a second sealing member 232 may be provided between the cover flange 245 and the chamber flange 215, so that when the cover 202 is mounted on the reaction chamber 201, the reaction space R and the separation space S may be hermetically sealed.

Specifically, in the cover 202, a groove 240a may be formed in a portion corresponding to an upper portion of the inner chamber 220, and the first sealing member 231 may be positioned within the groove 240a, so that when the cover 202 is mounted, the cover 202 and the reaction space R may be hermetically sealed (see FIG. 7). At this time, the groove 240a may be formed on the inner chamber 220 side instead of the cover 202 side, or the cover 202 and the inner chamber 220 may together form a space for the first sealing member 231 to be positioned.

In addition, also in the cover flange 245, a groove 240b may be formed, and the second sealing member 232 may be positioned within the groove 240b, so that the second sealing member 232 positioned between the cover flange 245 and the chamber flange 215 may hermetically seal the separation space S together with the first sealing member 231 (see FIG. 6). Similarly, the groove 240b may be formed on the chamber flange 215 side instead of the cover flange 245 side, or the cover flange 245 and the chamber flange 215 may together form a space for the second sealing member 232 to be positioned.

The first sealing member 231 and the second sealing member 232 may be, for example, an O-ring, and for example, a Chemraz product having corrosion resistance up to ˜310° C. or a Kalrez 4079 product (DuPont) having corrosion resistance up to ˜316° C. may be used.

The hydrogen gas supply pipe 205 and the first liquid sulfur supply pipe 204a may be connected to the cover 202. In addition, an outlet 206 and a liquid sulfur outlet 250 may be formed in the cover 202. The outlet 206 may be formed at a location corresponding to the reaction space R in the cover 202 so that hydrogen sulfide synthesized in the reaction space R may be discharged through the outlet 206. In addition, the liquid sulfur outlet 250 may be formed at a location corresponding to the separation space S in the cover 202 so that sulfur gas generated by vaporization of liquid sulfur accommodated in the separation space S may be discharged through the liquid sulfur outlet 250. The sulfur gas discharged through the liquid sulfur outlet 250 may be supplied again into the hydrogen sulfide reaction chamber 201 through the liquid sulfur supply pipe 204.

Meanwhile, similar to the outer chamber 210, the cover 202 may be made of one or more materials selected from the group consisting of Hastelloy X, stainless steel 304 (SUS 304), stainless steel 310 (SUS 310), stainless steel 316 (SUS 316), alumina, quartz, and a combination thereof. Therefore, the cover 202, the first sealing member 231, and the first liquid sulfur supply pipe 204a adjacent to the reaction space R are still at risk of corrosion by sulfur gas. Therefore, a cooling device 226 may be provided on an upper side of the inner chamber 220, that is, on the cover 202 side of the inner chamber 220. For example, the cooling device 226 may be configured to control the temperature of an upper space of the hydrogen sulfide reaction chamber to less than 200° C., and due to the above configuration, when the hydrogen sulfide gas synthesized in a lower space of the hydrogen sulfide reaction chamber moves to an upper portion of the hydrogen sulfide reaction chamber, the temperature of the gas is lowered to less than 200° C., thereby effectively preventing the cover 202, the first sealing member 231, and the first liquid sulfur supply pipe 204a from being corroded. The type of cooling device 226 is not particularly limited.

The hydrogen sulfide reactor according to the present invention may further include a flow path change member 225 formed on an inner surface of the inner chamber 220. The flow path change member 225 refers to a member that changes the flow path of hydrogen sulfide synthesized in the reaction space R to be longer than a straight path in order to prevent the hydrogen sulfide from flowing in a straight path toward the outlet 206.

For example, the flow path change member 225 may include a plurality of plates. One end of each plate may be connected to an inner surface of the inner chamber 220, and the other end may extend so as to be spaced apart from the inner surface of the inner chamber 220. In other words, a passage for fluid flow may be formed between the other end of the plate and an inner surface of the inner chamber 220. Alternatively, a passage for fluid flow may be formed to pass through the plate.

At this time, the plurality of plates 225 may extend from the inner surface of the inner chamber 220 so as to be inclined downward with respect to the horizontal direction. For example, the acute angle (α) formed between the inner surface of the inner chamber 220 and the plate 225 may be greater than or equal to 65° and less than 90° (see FIG. 7). Accordingly, the flow path of the hydrogen gas supplied to the reaction space R may be further extended, and liquid sulfur supplied from an upper portion of the inner chamber 220 may smoothly flow downward along the plurality of plates 225.

In addition, the plurality of plates 225 may be arranged such that the opposite ends of adjacent plates 225 are positioned in opposite directions. In other words, flow paths formed between adjacent plates 225 and the inner chamber 220 may be located in opposite directions so that the hydrogen gas movement path is lengthened, thereby increasing the contact time between the hydrogen gas and the liquid sulfur and enabling the production of high-yield and high-purity hydrogen sulfide.

Hereinafter, a process for producing hydrogen sulfide using the hydrogen sulfide reactor according to one embodiment of the present invention is described.

First, a user supplies liquid sulfur into the hydrogen sulfide reaction chamber 201. For example, after detaching the cover 202 from the hydrogen sulfide reaction chamber 201, liquid sulfur may be supplied to the reaction space R and the separation space S through an upper opening of the hydrogen sulfide reaction chamber 201, and then the cover 202 may be mounted on the hydrogen sulfide reaction chamber 201 again. Sealing members 231 and 232 may be provided between the cover 202 and the hydrogen sulfide reaction chamber 201 so that the reaction space R and the separation space S are hermetically sealed.

Alternatively, the user may supply liquid sulfur to the reaction space R through a first liquid sulfur supply pipe 204a and supply liquid sulfur to the separation space S through a second liquid sulfur supply pipe 204b while the cover 202 is mounted on the hydrogen sulfide reaction chamber 201. At this time, since the plate 225 formed in the inner chamber 220 extends from an inner surface of the inner chamber 220 to be inclined downward with respect to the horizontal direction, the liquid sulfur supplied to the reaction space R may smoothly move downward along the plate 225.

When liquid sulfide is supplied, the user operates the heating device 203 to heat the liquid sulfide accommodated in the reaction space R to a temperature of 300° C. or more and 600° C. or less. The heating device 203 may heat the liquid sulfide accommodated in the reaction space R via the liquid sulfide accommodated in the separation space S. Therefore, the inner chamber 220 may be prevented from being damaged or destroyed by direct heating by the heating device.

Next, the user supplies hydrogen gas into the liquid sulfur accommodated in the reaction space R via the hydrogen gas supply pipe 205. The supplied hydrogen gas reacts with the liquid sulfur to synthesize hydrogen sulfide. The heat of reaction generated when the hydrogen gas and the liquid sulfur react is recovered during contact with the liquid sulfur, thereby preventing the reaction temperature from rising excessively.

The supplied hydrogen gas moves upward toward the outlet 206 formed in the cover 202 and reacts with liquid sulfur to generate hydrogen sulfide. At this time, since the inner chamber 220 is provided with a flow path change member 225, the hydrogen gas does not move in a straight path toward the outlet 206, but the flow path thereof is made longer than the straight path by the flow path change member 225. Therefore, the contact time between the hydrogen gas and the liquid sulfur is increased, and accordingly, hydrogen sulfide can be generated at high yield.

Meanwhile, since the inner chamber 220 is formed of a highly corrosion-resistant material such as quartz, corrosion of the inner chamber 220 by liquid sulfur or synthesized hydrogen sulfide gas can be prevented. In addition, the user can operate the cooling device 226 provided on an upper side of the inner chamber 220 in order to cool the hydrogen sulfide gas moving upward and lower its activation level, thereby preventing the cover 202, the first sealing member 231, and the first liquid sulfur supply pipe 204a adjacent to the reaction space R from being corroded.

In addition, the cover 202 may be provided with a liquid sulfur outlet 250, through which sulfur gas evaporated in the separation space S is discharged. The discharged sulfur gas may then be re-supplied into the hydrogen sulfide reaction chamber 201 via the liquid sulfur supply pipe 204.

As described above, according to the present invention, the corrosion-resistant inner chamber 220 can be prevented from being damaged by direct heating by the heating device. In addition, corrosion of reactor components such as the cover 202, the first sealing member 231, and the first liquid sulfur supply pipe 204a can be effectively prevented. Furthermore, the reaction time between hydrogen gas and liquid sulfur can be increased, enabling the production of high-yield and high-purity hydrogen sulfide.

The above description is merely an illustrative description of the technical idea of the present invention, and those skilled in the art will understand that various modifications and changes can be made without departing from the essential features of the present invention. Therefore, the embodiments disclosed in the present invention are intended to illustrate, rather than limit, the technical idea of the present invention, and the scope of the technical idea of the present invention is not limited by these embodiments. The scope of protection of the present invention should be interpreted by the following claims, and all technical ideas within a scope equivalent thereto should be interpreted as being included in the scope of rights of the present invention.

### REFERENCE NUMERALS

10: Lithium raw material supply line
20: Hydrogen sulfide supply line
30: Lithium sulfide recovery line
40: Exhaust line
45: Recovery line
46 (46a and 46b): Branch line
47 (47a and 47b): Branch valve
48 (48a and 48b): Branch line
49 (49a and 49b): Branch valve
50: Re-supply line
60: Solvent re-supply line
100: Reaction chamber
150: Heating portion
200: Hydrogen sulfide supply portion
300: Condensation portion
400: Solvent re-supply portion
500: Moisture removal portion
515 and 515′: Discharge portion
520, 520′, and 520″: Desublimation cooling portion
521 (521a, 521b, 521c, and 521d): Cooling chamber
523: Main body
525: Cooling means
600: Lithium sulfide recovery portion
F: Filter member

What is claimed is:

1. An apparatus for mass-producing lithium sulfide, comprising:
a reaction chamber having a reaction space for producing lithium sulfide and provided with a lithium raw material;
a hydrogen sulfide supply portion provided to supply hydrogen sulfide to the reaction chamber;
a heating portion provided to heat the reaction space;
a lithium sulfide recovery portion provided to remove impurities from the lithium sulfide produced by a reaction between the hydrogen sulfide and the lithium raw material in the reaction chamber and recover only pure lithium sulfide;
a condensation portion provided to recover and condense gas discharged from the reaction chamber;
a solvent re-supply portion provided to receive a mixture from the condensation portion, selectively separate a reaction solvent, and supply the separated reaction solvent into the reaction chamber; and
a moisture removal portion provided to remove water vapor from recovered gas delivered from the solvent re-supply portion and then supply only hydrogen sulfide gas to a bottom of the reaction chamber, a hydrogen sulfide supply portion, or a hydrogen sulfide supply line.

2. The apparatus of claim 1, wherein a stirring member is further provided in the reaction chamber to promote a reaction between the supplied hydrogen sulfide and the lithium raw material.

3. The apparatus of claim 1, wherein the reaction chamber is made of one or more materials selected from the group consisting of Hastelloy X, stainless steel 304 (SUS 304), stainless steel 310 (SUS 310), stainless steel 316 (SUS 316), alumina, quartz, and a combination thereof.

4. The apparatus of claim 1, wherein the heating portion is mounted on an outer surface of the reaction chamber and heats the reaction space to a temperature to 120° C. or more and less than 300° C.

5. The apparatus of claim 1, wherein the lithium raw material supplied to the reaction chamber has a particle size of 1 mm or less.

6. The apparatus of claim 1, wherein the solvent re-supply portion is a Dean-Stark trap.

7. The apparatus of claim 1, wherein the moisture removal portion is a desublimation cooling portion that cools the gas recovered from the solvent re-supply portion and selectively removes only moisture from the gas.

8. The apparatus of claim 7, wherein the desublimation cooling portion includes a plurality of cooling chambers and a control portion controlling the desublimation cooling portion, and the control portion controls cooling so that, when the recovered gas is transferred to one or more predetermined cooling chambers among the plurality of cooling chambers, cooling is performed in the cooling chamber to which the recovered gas is transferred.

9. The apparatus of claim 8, wherein the control portion controls the cooling chamber to which the recovered gas is transferred, so that after cooling operation is performed for a predetermined time, the recovered gas is transferred to another cooling chamber, and causes heating to be performed for the cooling chamber that has performed cooling for the predetermined time to liquefy and remove ice desublimated by cooling.

10. The apparatus of claim 9, wherein the desublimation cooling portion has a plurality of branch lines for transferring the recovered gas to each of the plurality of cooling chambers and valves installed at the branch lines to open and close each of the branch lines, and the control portion is configured to determine a cooling chamber to which the recovered gas is transferred by controlling the valves.

11. The apparatus of claim 9, wherein the desublimation cooling portion has a main body provided to be rotatable around an axis parallel to a direction in which the recovered gas is transferred,
the plurality of cooling chambers are formed to pass through the main body in a direction parallel to the axis, and at least one of the cooling chambers is provided to communicate with a recovery line through which the recovered gas is transported and a re-supply line through which the recovered gas is re-supplied to the reaction chamber, and
the control portion controls the cooling chamber performing cooling to communicate with the recovery line and the re-supply line by rotating the main body around the axis.

12. The apparatus of claim 11, wherein the control portion controls the recovery line to communicate with another cooling chamber scheduled to perform a cooling operation by rotating the main body around the axis after the cooling chamber to which the recovered gas is transferred has been cooled for a predetermined time and causes heating to be performed for the cooling chamber that has been cooled for the predetermined time to liquefy and remove ice desublimated by cooling.

13. The apparatus of claim 1, wherein the hydrogen sulfide supply portion is a hydrogen sulfide reactor including an outer chamber and an inner chamber provided within the outer chamber so that a separation space is formed between the outer chamber and the inner chamber and having a reaction space for synthesizing hydrogen sulfide, and the inner chamber in the reactor has higher corrosion resistance than the outer chamber.
